(19) United States
(12) Patent Application Publication
(10) Pub. No.: US 2008/0028813 A1
(43) Pub. Date: Feb. 7, 2008

(54) Process and Production Line for Manufacturing Hot Ultrathin Steel Strips with Two Casting Lines for a Single Endless Rolling Line

(75) Inventors: Giovanni Arvedi, Cremona CR (IT); Luciano Manini, Azzanello CR (IT); Giacomo Soldi, Derovere CR (IT); Andrea Teodoro Bianchi, Piadena CR (IT)

Correspondence Address: LUCAS & MERCANTI, LLP, 475 PARK AVENUE SOUTH, 15TH FLOOR, NEW YORK, NY, 10016, US

(73) Assignee: Giovanni Arvedi, Cremona CR (IT)

(21) Appl. No.: 11/577,828

(22) PCT Filed: Oct. 21, 2005
(86) PCT No.: PCT/IT05/00613

§ 371 Date: May 15, 2007

(30) Foreign Application Priority Data
Oct. 28, 2004 (EP) 04425805.1

(51) Int. Cl. B21B 39/00

(52) U.S. Cl. 72/226

(57) ABSTRACT

A production line for hot steel strips, being fed from two casting lines (a, b) for thin slabs of thickness <100 mm, only one of which (a) is aligned with a finishing rolling mill (g), comprises also two pairs of rotatable heating furnaces with mandrel (A1, A2, B1, B2), each respectively on either line, with an intermediate bypass section (d) between the furnaces of the first pair (A1, A2) to allow the endless rolling in a finishing rolling mill (g) locate downstream. The furnaces (B1, B2) of the second pair of furnaces on the line (b) can be transferred along a path (k) from said line to the rolling line and vice versa for producing single strips. Furthermore an induction furnace (f) is provided upstream of the finishing rolling mill (g). Also the corresponding production process is described.

The present invention relates to a production line for manufacturing ultrathin hot strips, comprising two casting lines for thin slabs and a single rolling line for endless operation, i.e. without solution of continuity, as well as the corresponding process of production.

For the manufacturing of hot steel strips it is known to use thin slab plants which allow that two casting lines and one rolling mill are connected to eaclh other, but there has never been provided the possibility of rolling the product to obtain ultrathin strips continuously.

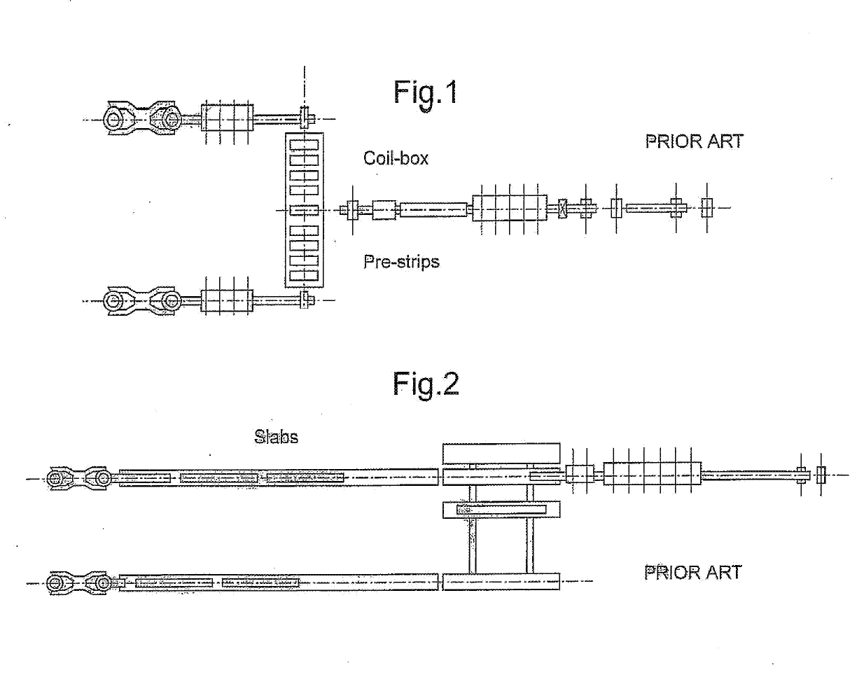

In a known thin slab plant with two casting lines the rolling mill has been positioned centrally between the two lines to which it is connected through a “coil-box” at the inside of which a pre-strip, wound on itself, is transferred each time to the rolling mill by means of “step by step” or “walking-beam” systems. Therefore it is unavoidable that the rolling mill feeding is interrupted and am endless rolling cannot take place without solution of continuity, as it clearly results from the representation of this prior art technique, as shown in FIG. 1.

A second way of producing hot strips from two casting lines with a single rolling mill provides for two long tunnel furnaces, each aligned with the respective casting line and only one of them aligned with the rolling mill, wherein the single slabs, each of which corresponding to a single coil, are heated at the inside of said furnaces. Both of them have the end portion formed as am independent section that can be moved from one line to the other and has a sufficient length to contain entirely a section of slab corresponding to a coil. This it is possible to roll also the slabs of the second casting line, which is not aligned with the rolling line. However there are still problems for a possibly endless rolling operation both under technological aspects, due to an excessively low speed at entering the rolling mill, which is the same as the casting speed, and for technical problems relating to the handling of a single lab of about 300 meters length at the inside of a heating furnace. This solution is schematically shown in FIG. 2.

EP 1196256, in the name of the present applicant, discloses in a system for producing ultrathin strips the use of two casting lines connected to a rolling mill in a central position, being fed from four furnaces with inner mandrels to allow winding/unwinding steps of a pre-strip, capable of rotating and shifting at the same time towards the central area where the rolling mill is located. But also this solution is unable to obtain a rolling operation which is actually “endless”, since the rolling mill is not co-axial with any of the two casting lines, whereby a displacement of the furnaces therefrom to the rolling mill is always necessary. Furthermore the times required by the cycle of “transfer-rotation and subsequent return” of the four furnaces are very narrow and critical, especially in concomitance of interventions on the rolling mill, such as the replacement of rolls during the casting sequence, as it is required in any case winding of pre-strips weighing at least 50 tons to reduce the narrowness of the cycle time. As a consequence the dimensioning of the equipments would become excessive and the relevant plant system very complex and burdensome from the viewpoint of costs.

Therefore it is an object of the present invention to provide a production line that, by overcoming the prior art inconveniences, allows the manufacturing of hot steel strips from two casting lines making it possible to have an endless rolling, i.e. without any discontinuity Similarly it is also an object of the present invention to provide a process for the manufacturing of hot ultrathin strips of steel wherein the rolling of product from two distinct lines takes place in respect of single strips and, from one of said lines, without solution of continuity.

It has been found that, with one of the casting lines being aligned with the rolling mill and having the pre-strip at its outlet a thickness of less than 30 mm, the latter can be conveyed directly to the final rolling step, as instead this could not be made with the above-mentioned prior art systems. Both in the first (FIG. 1) and third case (EP 1196256) in fact the pre-strips coming from the casting lines would have a speed suitable for an endless rolling, but the rolling mill is not aligned with any of both lines, whereas in the second case (FIG. 2) the rolling mill is aligned with one of the two casting lines, but however there is a solution of continuity due to the fact that the slabs being fed in turn to the rolling mill correspond each one to a single coil, whereby are separated from each other.

Another object of the present invention is also that of solving the problem of the critical time, which is peculiar of the prior art as pointed out above, because when transferring only one pair of heating furnaces, sufficient ranges of time are allowed for the usual operations of normal or emergency maintenance.

A further object of the present invention is also that of providing the possibility of a safer management of two casting lines being interconnected to each other by means of superimposed furnaces, being provided of internal mandrel and capable of producing at least two million tons/year of hot steel strip and, at the same time, performing an endless rolling for manufacturing thin strips of a thickness lower than 1 mm.

Yet another object of the present invention is that of reducing the temperature loss in the descaling step, by so operating that the temperature at entering the heating furnaces is lower (about 900° C.) with respect to that of about 1100° C. foreseen by the prior art, in order to reduce the scale production and consequently the problems relating thereto in the winding/unwinding step in the heating furnaces and between the inlet and outlet rolls, such as possible scale tracks on the strip itself.

These objects are achieved through a production line and relevant process as defined in the following claims.

These and other objects, advantages and features of the invention will be clearer from the following description, given boy a non-limiting example, of a production line and relevant process, with reference to the annexed drawings wherein:

FIGS. 1 and 2 are two diagrammatic plan views of two systems for manufacturing hot steel ultrathin strips from two casting lines;

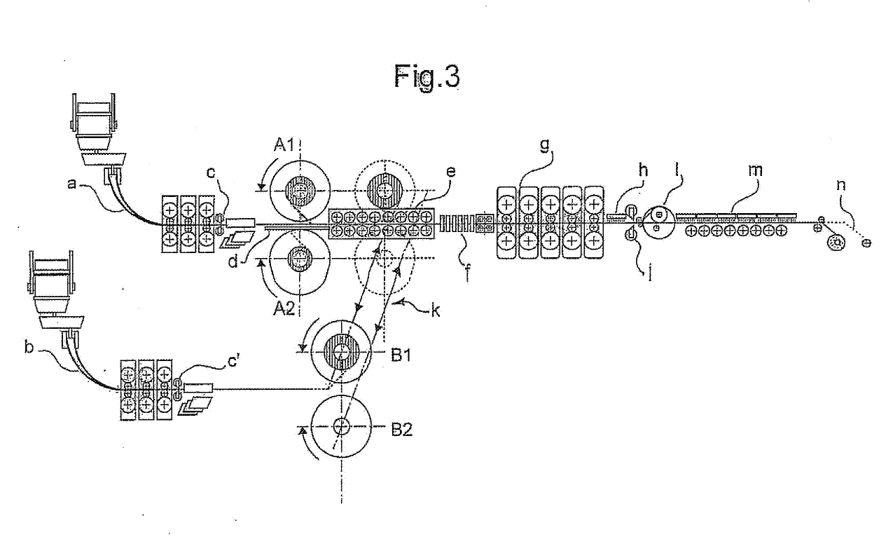

FIG. 3 diagrammatically shows a side elevation view of a production line according to the present invention; and

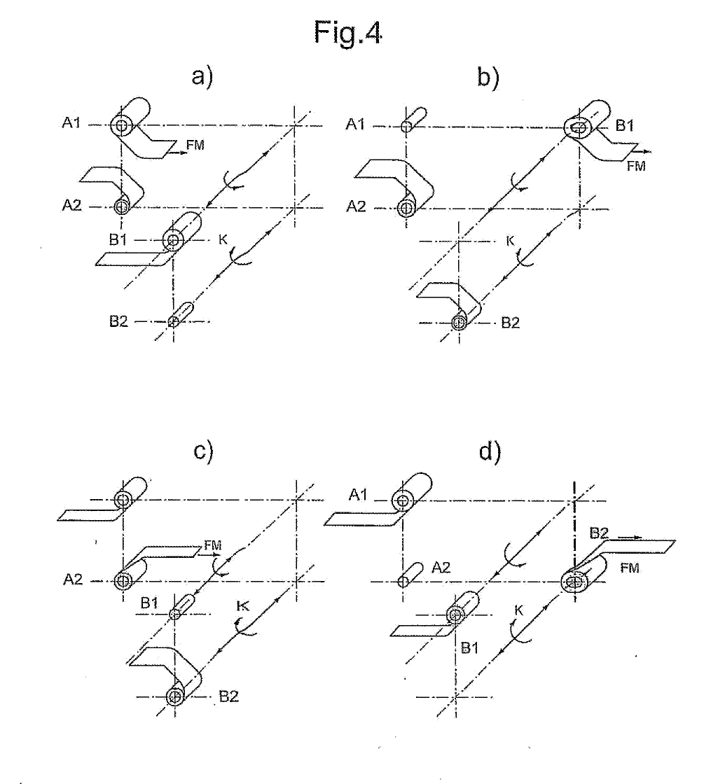

FIG. 4 shows, in subsequent schematic views, the steps and sequences of the winding-unwinding-rolling cycle of the four heating furnaces being present in the plant of FIG. 3 when no use is made of the endless rolling system.

With reference to FIG. 3, there are indicated with a, b, two thin slab casting lines, with liquid core reduction and direct rolling (roughing) connected thereto, as already disclosed in EP 1196256. Each line is followed by a shear c, c′ for cutting the pre-strip, to be operated when the single strips production is foreseen, to feed two respective pairs of gas supplied heating furnaces, being provided of internal mandrel A1, A2, pertaining to line a, and B1, B2 pertaining to line b. As it is known, said heating furnaces are able to be shifted and rotated on their axis to ensure that a pre-strip is received from the respective upstream line and is forwarded to a downstream finishing mill g. A bypass section d is provided between furnaces A1, A2 of the first pair of furnaces on the line a to allow the endless rolling in said rolling mill g after a thermally insulated roller path e of the continuous pre-strip, not being cut by shear c.

Of course with such a system it is also possible to have the rolling operation for single strips and to this end the pair of heating furnaces with mandrel B1, B2, staggered with respect to line a with which the rolling mill g is aligned, can move to such a line (in particular in place of the roller path e, also movable but to the opposite direction) as well as to come back to the initial position along a path k, there being provided means for such a movement. The system is completed by an induction heating furnace f downstream of the roller path e and upstream of the finishing mill g with subsequent compact, rapid cooling h; flying shear i for cutting the strips upon reaching the required weight; carousel-type winding reel l, to be used in the endless rolling without solution of continuity; roller path m for the transfer to cooling water sprays; and downcoiler n for the final winding of the product coming from both the casting lines with discontinuity.

With reference to FIG. 4, with diagrammatic representation of pre-strip coils being wound on two pairs of heating furnaces A1, A2 and B1, B2, as well as of the path k, schematically represented by rectilinear arrows (while the bent arrows represent the rotation direction of the axes of the furnaces B1 and B2 during the rotation itself), there are pointed out steps and sequences of the winding-unwinding-rolling cycle of the four heating furnaces whenever the endless rolling system is out of operation. More precisely, in FIG. 4a the situation is illustrated in which the content of furnace A1 is under rolling, as schematically indicated by arrow FM to show the direction toward the “finishing mill” g. FIG. 4b represents the subsequent step in which the whole product of furnace A1 has been rolled, the pre-strip of a subsequent coil is still winding in the furnace A2 and under rolling there is the content of furnace B1 which in the meantime has been shifted along the finishing mill line, having completed its winding, while an other coil fed from line b is forming in furnace B2. In FIG. 4c it is now the pre-strip coil of furnace A2, fully wound in the meantime, that feeds the finishing mill, while furnace B1, now empty, has reached back again its initial position and furnace B2 has almost completed its feeding with the coil which subsequently, as shown in FIG. 4d, is placed on the rolling line, upon shifting along the path k, while the coil in A1 is almost fully wound to restart again the cycle with the situation of FIG. 4a, A2 is empty and B1 starts winding a new coil on the line b.

From the above it results that through the transfer of only one pair of heating furnaces, with respect to the solution provided in EP 1196256, the advantage is obtained that ranges margins of time are available, as already pointed out above.

In addition, the induction furnace f being located downstream of the heating furnaces with mandrel, at the entry of the finishing rolling mill, rather than upstream of said furnaces, as disclosed in EP 1196256, results in having a temperature of about 900° C. instead of 1100° C. downstream of the casting and roughing line. Furthermore, during heating in the induction furnace f, a re-oxidation of the material takes place, which causes the scale formed in the previous “Cast Rolling” step to re-emerge, with the advantage of rendering possible the descaling with a lower water pressure and quantity, while improving at the same time the surface quality of the strips.

The pre-strip thickness is less than 30 mm and, to keep the coil weight in the movable furnaces B1 and B2 within acceptable limits, can even reach values lower than 15 mm. The thickness of the rolled strip can be comprised between 1.0 and 12.0 mm when single strips are to be manufactured from both casting lines a and b, by using both pairs of heating furnaces with mandrel. However there is also the possibility of obtaining ultrathin strips continuously, with thickness <1,0 mm by using only the casting line a aligned with the rolling mill g.

It should be noted that the low descaling pressure and the reduced water level, with respect to those prevailing in the traditional “minimills” making use of the thin slab technology, involve a reduction of the temperature losses in the pre-strip, this being a necessary condition for making possible to produce ultrathin strips with a thickness <1.0 mm.

1. A production line for manufacturing hot steel strips from two casting lines (a, b) for thin stabs of thickness ≦100 mm, only one of which (a) is aligned with a rolling line (e, g) characterized by comprising two mutually superimposed pairs of heating furnaces (A1, A2; B1, B2) with respective mandrels, one first pair (A1, A2) mounted stationary on said casting line (a) being aligned with the rolling line (e, g), and the second one B1, B2) movable mounted on line (b), being capable to be transferred towards the other line, both pairs of furnaces being provided with respective internal mandrels for winding/unwinding of pre-strips having thickness lower than 30 mm, further comprising a bypass length (d) between said two furnaces (A1, A2) for ensuring the endless transfer to a finishing rolling mill (g) through a roller path (e), and transverse path (k) operable in the batch production for transferring said pair of furnaces (B1, B2) from line (b) to line (a), there being provided an induction furnace (f) downstream of said heating furnaces with mandrel and immediately upstream of said finishing rolling mill (g).

2. A production line according to claim 1, characterized by comprising on each line (a, b), upstream of said pairs of heating furnaces with mandrel, a respective shear (c, c′), wherein one of them (c) being mounted on line (a) is operated, in alternative to the other shear (c′) on line (b), for the cutting of prestrip only in the batch production with discontinuous rolling.

3. A production line according to claim 1, characterized by comprising, downstream of the rolling mill (g), a flying shear (i) with operating means to cut the finished strip upon reaching a predermined value of the coil weight, in the endless production.

4. A production line according to claim 1, characterized in that said bypass length (d) is formed as thermally insulated roller path being aligned with said rolling line (e, g).

5. A production line according to claim 2, characterized by comprising means for transferring said second pair of furnaces (B1, B2) along said transverse path (k) in synchronism with the rolling steps of product from this one and the first pair of furnaces (A1, A2).

6. A production line according to claim 1, characterized in that said roller path (e) can be moved in a transverse direction with respect to said line (a) and rolling mill (g) in a direction opposite to the transfer path (k) for the second pair of furnaces (B1, B2).

7. A process for manufacturing of ulterthin hot steel strips, being fed from two casting lines for thin slabs with thickness ≦100 mm to a single rolling line, one first of which being aligned with the rolling line, characterized by comprising for each line a liquid core reduction step and subsequent roughing to obtain a slab or pre-strip with thickness <30 mm to be to be wound on rotatable heating means and subsequently rolled, upon unwinding, with the possibility of either using only the said first casting line, without solution of continuity through a by-pass section and finishing rolling step, to obtain ultrathin strips having thickness <1.0 mm, or producing in batch single strips of thickness from 1.0 and 12.0 mm, upon cutting before winding, for each casting line, on said rotatable heating means, there being provided a transferring step of said heating means relating to the casting line which is not aligned with the rolling line, to bring said heating means into correspondence with said first line an cause them to come back to the starting position.

8. A manufacturing process according to claim 7, characterized by further comprising an induction heating step between said heating rotating means and said finishing roiling.

9. A process according to claim 7, wherein the pre-strip temperature at the end of the casting line, in correspondence with winding for the production of single strips, is of about 900° C.

10. A process according to claim 8, wherein the pre-strip temperature at the end of the casting line, in correspondence with winding for the production of single strips, is of about 900° C.
